(19) United States
(12) Patent Application Publication
(10) Pub. No.: US 2026/0179009 A1
(43) Pub. Date: Jun. 25, 2026

(54) System

(71) Applicant: SoftBank Group Corp., Tokyo (JP)

(72) Inventor: Takato Ando, Tokyo (JP)

(21) Appl. No.: 19/429,145

(22) Filed: Dec. 22, 2025

(30) Foreign Application Priority Data
Dec. 24, 2024 (JP) 2024-227748

(51) Int. Cl. G06Q 10/0631

(52) U.S. Cl. CPC G06Q 10/06312

(57) ABSTRACT

A system includes a processor that acquires observation information comprising environmental information including structures, moving objects, and luminance states in a plurality of spatial regions, acquires interview information provided by regional stakeholders as opinion information, generates an instruction sentence for predicting regional environmental characteristics for a plurality of future periods based on the observation information and the interview information, inputs the instruction sentence generated by the instruction sentence generation to a generative AI model, and acquires prediction information indicating the regional environmental characteristics for the plurality of future periods from the generative AI model, and generates and outputs indicator information applicable to resource allocation policy or business planning based on the prediction information.

### CROSS-REFERENCE TO RELATED APPLICATION

This application is based on and claims priority under 35 USC 119 from Japanese Patent Application No. 2024-227748 filed on Dec. 24, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional regional planning and resource allocation processes, it has been difficult to accurately predict future regional environmental characteristics due to the insufficiency of integrating objective observation data and subjective stakeholder opinions. Furthermore, creating comprehensive and timely policy indicators or business plans has traditionally required significant manual labor, expert intervention, and has often resulted in information delays and inefficiencies.

### SUMMARY

The present invention provides a system comprising a processor that acquires observation information, including environmental data such as structures, moving objects, and luminance states in multiple spatial regions, and also acquires interview information provided by regional stakeholders. The processor integrates and analyzes these data sources to generate an instruction sentence, which is input to a generative AI model in order to obtain prediction information regarding future regional environmental characteristics. Based on the obtained prediction information, the processor generates and outputs indicator information which can be utilized for resource allocation policy or business plan formulation, thereby automatically and efficiently supporting accurate regional planning.

“Observation information” means data including environmental details such as structures, moving objects, and luminance states collected from a plurality of spatial regions.

“Interview information” means opinion-based information provided by regional stakeholders, reflecting their subjective perspectives and insights regarding the relevant area.

“Instruction sentence” means a structured input generated for a generative AI model, formulated using both observation information and interview information, and intended to prompt the AI to predict future regional environmental characteristics.

“Generative AI model” means an artificial intelligence system capable of producing predictive or analytical responses based on provided input data, particularly for generating forecasts of regional environmental changes.

“Prediction information” means output data obtained from the generative AI model, indicating expected regional environmental characteristics for one or more future periods.

“Indicator information” means synthesized data derived from prediction information, which can be applied for determining policies regarding resource allocation or for the formulation of business plans.

“Resource allocation policy” means a strategic guideline for the optimal distribution of available resources in a region, developed on the basis of analyzed data and predicted regional needs.

“Business plan” means a structured proposal or strategy for executing commercial or developmental activities within a region, prepared by referencing outputs such as indicator information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### FIRST EXEMPLARY EMBODIMENT

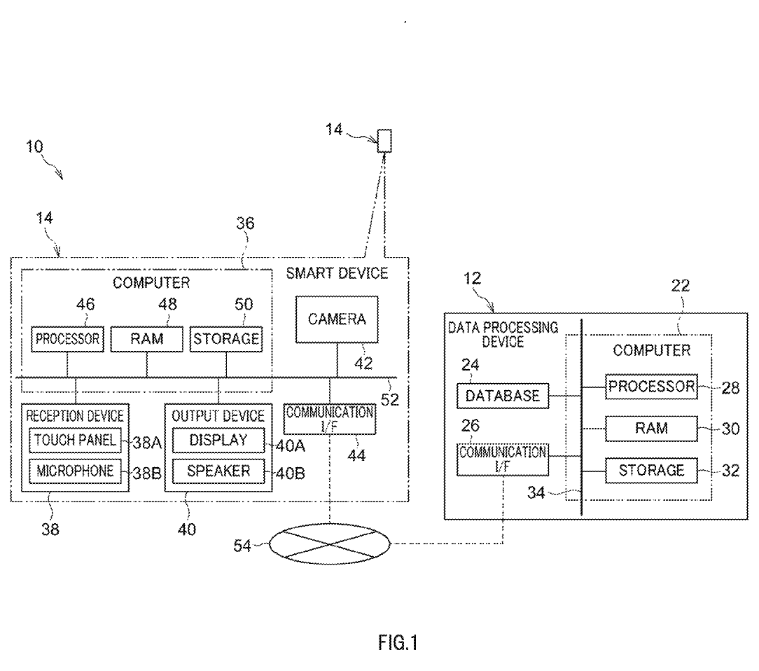

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

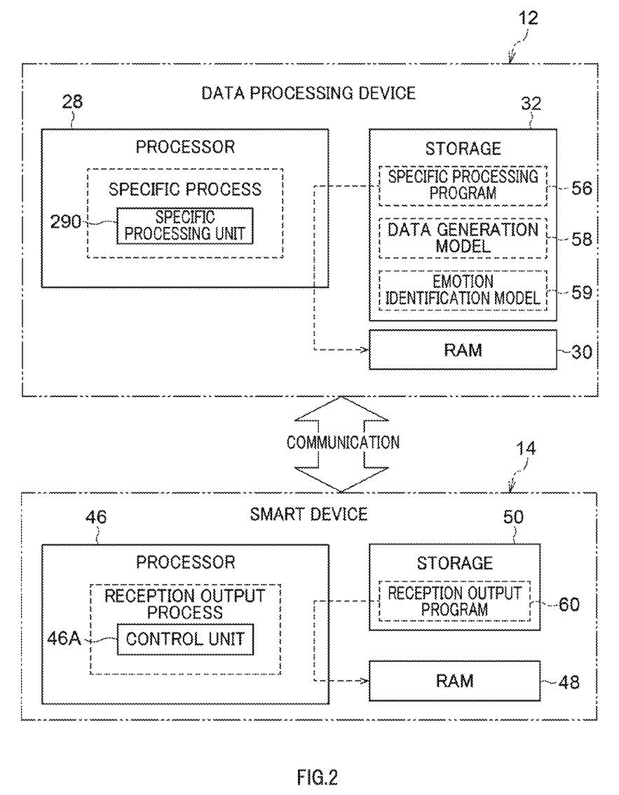

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In recent years, effective revitalization and sustainable development of regional communities require accurate and comprehensive understanding of local environmental characteristics for proper formulation of resource allocation policies and business plans. However, conventional methods encounter difficulty in integrating and analyzing large amounts of environmental and stakeholder data from multiple sources in an intuitive and timely manner. Furthermore, it is challenging to forecast future regional trends by dynamically utilizing both objective observation data and subjective opinions from local stakeholders, and to provide actionable strategic information for policy or investment decision-making.

The specific processing by the specific processing unit 290 of the data processing device 12 in Example 1 is realized by the following means.

The present invention provides a server comprising a processor configured to acquire observation data including object information, moving object information, and illuminance information for multiple spatial regions; acquire hearing data including stakeholder opinions; generate instruction sentences based on the observation and hearing data for prediction of future regional environmental characteristics; utilize a generative information processing model to obtain predictive data; process and organize the predictive data to generate indicator data for resource allocation or business planning; and visualize such indicator data for user decision-making. This enables comprehensive, objective, and future-oriented analysis integrating diverse real-world and opinion data, and provides quantifiable guidance for effective resource allocation or business policy creation in regional environments.

The term “observation data” refers to information collected from the external environment of a plurality of spatial regions, including but not limited to object information, moving object information, and illuminance information, obtained via sensor devices, recording devices, or communication devices.

The term “hearing data” refers to information representing opinions, experiences, or subjective insights provided by regional stakeholders, such as residents, business operators, or local officials.

The term “object information” refers to data describing the presence, attributes, or status of physical structures or objects within a spatial region.

The term “moving object information” refers to data related to the movement, position, or trajectory of mobile entities, which may include vehicles, pedestrians, or other movable objects, within a spatial region.

The term “illuminance information” refers to quantitative data regarding the level or intensity of light present in a spatial region, measured by light sensors or similar environmental measurement devices.

The term “instruction sentence” refers to a structured command or request, generated in natural language based on observation data and hearing data, and used as input to a generative information processing model to prompt prediction of future regional environmental characteristics.

The term “generative information processing model” refers to a trained information processing system, such as a generative artificial intelligence model, capable of producing prediction results or other outputs in response to input instruction sentences.

The term “predictive data” refers to information output by the generative information processing model, indicating predicted future characteristics, trends, or features of regional environments for specified future time points.

The term “indicator data” refers to data processed and organized from predictive data, providing quantitative or qualitative indices which support resource allocation policy or business planning for regional environments.

The term “information analysis methods” refers to computational approaches including, but not limited to, natural language processing, image processing, and time series analysis, used for extracting patterns or features from observation and hearing data.

The term “visualization means” refers to hardware and/or software configured to represent indicator data in a way that is accessible and understandable to users, such as graphical displays, maps, charts, or dashboards.

The term “processor” refers to one or more computing units, hardware or virtual, capable of executing instructions to perform data acquisition, processing, analysis, and communication as described in the system.

The present invention may be embodied as a regional environment analysis and prediction system that integrates sensor-based observation data and hearing data obtained from stakeholders to generate future-oriented indicator data for use in resource allocation or business planning.

The system comprises a server and at least one terminal device. The terminal serves as a data collection and user interface device, while the server performs data analysis, prediction, and indicator generation.

The terminal may be implemented as a mobile or stationary information processing device, such as a microcomputer, tablet, or laptop computer. The terminal is equipped with various information collection means including, but not limited to, a digital imaging device (such as a generic camera), an audio input device (such as a generic microphone), light sensors, temperature and humidity sensors, and other environmental sensors compatible with general purpose platforms (for example, Raspberry Pi or similar hardware). The terminal executes data acquisition and preprocessing software, for instance, using programming languages such as Python, together with open-source libraries such as OpenCV for image analysis, Whisper or similar engines for speech recognition, and standard communication libraries for sensor input (such as I2C).

The terminal collects observation data such as images or ambient environmental readings, and records stakeholder interviews or comments using its input devices. The terminal preprocesses these data (for example, compressing images, transcribing audio, or normalizing sensor values), structures the information with metadata such as timestamps and location data, and transmits the preprocessed data to the server using a standard communication protocol, such as HTTP.

The server is a general-purpose computing device (such as a workstation or virtual machine) running a widely-used operating system (such as Linux). The server stores collected data in a database management system (such as a relational database), and executes analysis software implemented in a high-level programming language (for example, Python). The analysis software uses libraries and tools for data processing, including but not limited to pandas for tabular data management, spaCy for natural language processing, OpenCV for image data refinement, and statsmodels for time series analysis.

The server integrates the observation data and hearing data, extracting relevant features and patterns. For instance, the server may use spaCy to extract keywords and sentiment from the transcribed stakeholder comments, apply OpenCV to detect the number of moving objects in images, or use statsmodels to identify trends in time-series sensor data such as changes in illuminance or pedestrian flow.

Using the extracted features, the server generates an instruction sentence in natural language to serve as an input prompt for a generative AI model (also referred to as a generative information processing model). Communication with the generative AI model may be accomplished via an application programming interface (API) such as a generic cloud-based language model service. The instruction sentence is dynamically composed according to the data received and may incorporate both objective and subjective factors. An example of such a prompt sentence is as follows:

"Below is observation data over the past two years in a regional area (traffic increase rate, variance in nighttime brightness index, growth in nighttime activity among young people) and opinions gathered from residents or business owners: 'The area where young people gather at night is becoming more lively.' Based on this data, comprehensively predict and summarize, for the next 2-3 years in this region, the possibility for commercial area expansion, infrastructure development requirements, and changes in residential environment."

The server submits this instruction sentence to the generative AI model and receives predictive data indicating anticipated future characteristics relevant to the regional area, such as priority for commercial investment or need for infrastructure improvement.

The server processes and organizes the predictive data, generating indicator data as quantitative or qualitative indices (for example, investment priority scores, estimated payback periods, urgency of infrastructure upgrades). The server then transmits this indicator data to the terminal.

The terminal receives the indicator data, which is visualized using graphical interface software (e.g., HTML, CSS, JavaScript libraries; map display libraries such as Leaflet or Mapbox). Indicator data is displayed in an intuitive format such as color-coded maps, bar charts, summary reports, or interactive dashboards, which are accessible by the user.

The user reviews, interprets, and utilizes the visualized indicator data to formulate or revise resource allocation policies, plan investment or operations, or facilitate strategic discussions in regional management contexts.

This system may be implemented with components and software that are well known in the field, and is not limited to the specific examples above. The predictive model, data sources, analytics, and user interfaces may be customized according to the needs of a particular application or environment.

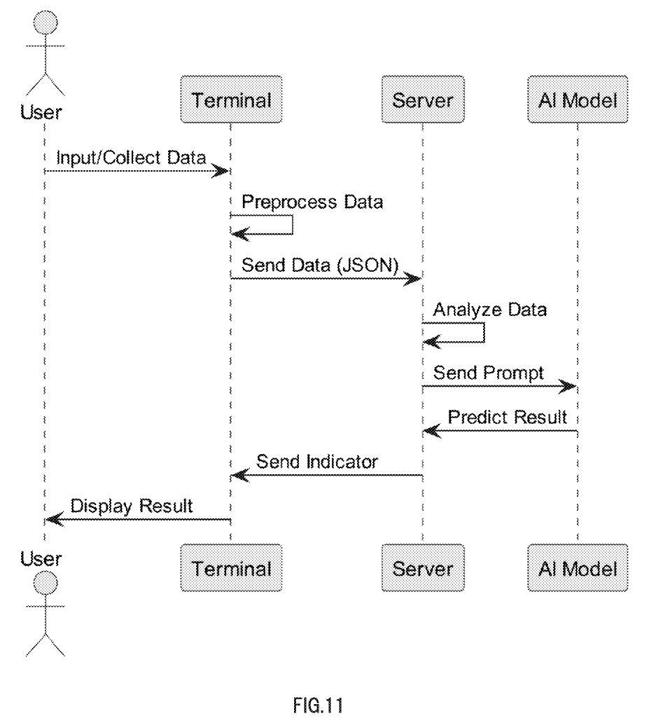

The following describes the processing flow using FIG. 11.

### Step 1:

The terminal acquires observation data and hearing data by operating connected devices such as a camera, microphone, light sensor, and temperature/humidity sensor. As input, the terminal receives raw media files (images, audio recordings) and sensor values. The terminal executes data acquisition scripts in Python, triggering devices to collect snapshot images, audio samples from stakeholder interviews, and environmental measurements. The output of this step is a collection of raw observation and hearing data files with metadata including timestamps and geographic coordinates.

### Step 2:

The terminal preprocesses the acquired data and prepares it for transfer. As input, the terminal uses the raw data acquired in Step 1. The terminal runs OpenCV to perform image feature extraction such as object counting or motion detection, and uses a speech recognition engine (such as Whisper) to convert audio from interviews into text format. Sensor data is validated and normalized. All processed information is structured into a standardized JSON object that includes extracted features, transcribed text, and sensor values. The output of this step is the formatted observation and hearing data ready for network transmission.

### Step 3:

The terminal transmits the preprocessed and formatted data to the server via a communication protocol such as HTTP POST. As input, the terminal uses the JSON object prepared in Step 2. The server receives the JSON payload, using a web server interface, and stores it in a structured database. The output of this step is a persistent record of observation and hearing data in the server’s data storage, indexed by time and source.

### Step 4:

The server processes and analyzes the stored data. As input, the server uses the structured observation and hearing data retrieved from the database. The server runs data processing routines in Python, using pandas to format time series, spaCy to extract keywords and sentiment from stakeholder texts, and statsmodels to compute statistical trends from quantitative values (e.g., illuminance, crowd density). The output of this step is an enriched dataset containing key extracted features, trend metrics, and summarized stakeholder content.

### Step 5:

The server generates a prompt sentence for the generative AI model. As input, the server uses the enriched features and summaries from Step 4. Based on these inputs, the server constructs a natural language instruction sentence that encapsulates localized trends, extracted keywords, and relevant stakeholder perspectives. For example, the prompt sentence may state: "Below is observation data over the past two years in a regional area (traffic increase rate, variance in nighttime brightness index, growth in nighttime activity among young people) and opinions gathered from residents or business owners: 'The area where young people gather at night is becoming more lively.' Based on this data, comprehensively predict and summarize, for the next 2-3 years in this region, the possibility for commercial area expansion, infrastructure development requirements, and changes in residential environment." The output of this step is a fully-formed prompt sentence.

### Step 6:

The server submits the prompt sentence to a generative AI model and receives prediction results. As input, the server uses the prompt sentence generated in Step 5. The server sends the prompt to a cloud-based generative AI model API and waits for the model’s output, which is a natural language description of predicted future regional environmental characteristics, such as investment priority or infrastructure needs. The output of this step is the response (prediction result) from the generative AI model.

### Step 7:

The server extracts relevant indicator data from the generative AI model’s prediction results. As input, the server uses the received prediction response text from Step 6. The server applies text mining or rule-based scripts to identify key recommendations, such as high-priority investment areas or estimated infrastructure upgrade periods. The output of this step is a structured indicator data set, formatted as JSON, with each indicator mapped to spatial regions or policy categories.

### Step 8:

The server transmits the indicator data to the terminal for visualization. As input, the server uses the structured JSON indicator data from Step 7. The server sends this data to the terminal using HTTP protocols or pushes updates through a notification mechanism. The output of this step is the successful delivery of the indicator data to the terminal.

### Step 9:

The terminal visualizes the received indicator data for the user. As input, the terminal uses the indicator data provided in Step 8. The terminal runs a visualization module in a web browser or application, employing tools such as Leaflet or Mapbox to display maps with color-coded attributes, bar charts, and text summaries. The terminal generates interactive visualizations that allow the user to explore results by spatial region or policy metric. The output of this step is a graphical user interface displaying actionable indicator data.

### Step 10:

The user reviews and utilizes the indicator data for planning or policy making. As input, the user interprets information presented by the terminal’s user interface in Step 9. The user may compare regional priorities, export data for meetings, or use insights to draft investment or operational strategies. The output of this step is an informed decision or action plan for regional resource allocation or business operation, based on the generated indicators.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional regional information systems, there are significant challenges in efficiently collecting, integrating, and analyzing diverse data sources such as visual data, audio data, and spatiotemporal information to provide real-time and practical regional situational awareness. Existing methods often lack the capability to accurately recognize object quantities, convert and analyze user-supplied speech, detect correlations among heterogeneous datasets, and dynamically generate suitable prompts for advanced artificial intelligence models. As a result, it is difficult to deliver effective regional forecasts, resource allocation strategies, or timely information to users based on current and predicted regional situations.

The specific processing by the specific processing unit 290 of the data processing device 12 in Application Example 1 is realized by the following means.

The present invention provides a server comprising a processor configured to collect image information from visual acquisition devices, recognize and quantify objects, transcribe audio information to character information with emotion analysis, correlate multiple datasets including spatiotemporal data, generate prompt sentences for input to a generative AI model based on processed data, obtain prediction information relating to future regional situations, and output display information and index data for supporting resource allocation or policy planning. This enables comprehensive and timely regional situation analysis, automatic generation of dynamic prompts for AI models, real-time delivery of relevant information to users, and efficient support for strategic planning and resource allocation based on predicted circumstances.

The term “image information” refers to data representing visual content, such as photographs, video streams, or image files, acquired from a visual information acquisition device such as a camera.

The term “visual information acquisition device” refers to any apparatus or hardware, including cameras or image sensors, that is capable of capturing visual or image data from a physical environment.

The term “object” refers to a distinguishable entity or feature present within the image information, such as a person, vehicle, building, or any relevant item to be recognized or counted.

The term “acoustic acquisition device” refers to any apparatus or hardware capable of capturing audio data from an environment, including but not limited to microphones or audio recorders.

The term “audio information” refers to data representing sound, including voice recordings, environmental sounds, or other audible signals obtained from an acoustic acquisition device.

The term “speech recognition processing” refers to a computational process that converts audio information into character or textual information, typically by analyzing spoken language.

The term “character information” refers to textual data produced as a result of speech recognition processing, representing the semantic or linguistic content of the original audio information.

The term “emotion classification processing” refers to an analysis procedure that classifies character information into emotional states, such as positive, negative, or neutral, based on linguistic and contextual cues.

The term “correlation analysis” refers to a statistical or computational method for identifying and quantifying relationships or associations among two or more sets of data.

The term “spatiotemporal data” refers to information that includes both spatial (location-related) and temporal (time-related) attributes.

The term “location information detection device” refers to any device capable of determining or acquiring geographic position data, such as a global positioning system (GPS) receiver.

The term “user terminal” refers to an electronic device, such as a smartphone, tablet, or computer, capable of receiving, processing, and displaying data to a user.

The term “prompt sentence” refers to a formulated text statement or query generated for the purpose of inputting into a generative AI model to elicit relevant prediction or output.

The term “generative AI model” refers to an artificial intelligence model that is capable of producing predictive, analytical, or creative outputs based on received input data, such as a large language model or neural network.

The term “prediction information” refers to data output by the generative AI model representing anticipated or forecasted future situations or conditions relating to regional circumstances.

The term “display information” refers to data that has been processed and formatted for visual presentation to a user, typically through a display interface on a user terminal or display device.

The term “index information” refers to a derived metric, parameter, or indicator generated from data analysis or prediction results, suitable for supporting resource allocation, strategic planning, or decision making.

The term “resource allocation” refers to the process of distributing resources, such as personnel, equipment, or funding, to various tasks, projects, or spatial regions in accordance with planning objectives.

The term “policy planning” refers to devising, formulating, or establishing strategies or courses of action aimed at achieving specific regional or organizational goals based on available data and predictive insights.

One embodiment of the present invention provides a system configured for comprehensive regional data analysis and forecasting, utilizing a combination of hardware and software components to collect, process, analyze, and display information relevant to regional situations.

The server is equipped with a processor and necessary interfaces to receive visual data from visual information acquisition devices such as digital network cameras installed at key locations within a targeted area. These cameras periodically capture image data, such as JPEG or video streams, and transmit them over a communication network (for example, via HTTP or FTP) to the server for processing. The server can utilize image processing software, such as OpenCV and TensorFlow, to detect and count objects like people or vehicles within these images.

The user can acquire audio information by conducting interviews or gathering opinions from local stakeholders using a microphone or audio acquisition device integrated into a user terminal, such as a smartphone. The terminal transmits the collected audio data (for example, in WAV format) to the server through a designated API endpoint. The server then applies speech recognition processing, such as a cloud-based speech-to-text service, to convert the audio information to character information. Following this, the server applies an emotion classification module, such as a sentiment analysis engine using natural language processing technology, to categorize the content as positive, negative, or neutral.

The server aggregates various types of data, such as object count data from images, transcribed text data from audio, and their associated spatiotemporal attributes. Statistical analysis software, such as Python libraries (pandas, scipy), can be used to perform correlation and trend analysis to detect patterns among multiple data sources. The results of these analyses can be formatted and delivered to the terminal as display information, for example, as graphs, heatmaps, or alerts about area congestion, using application frameworks like React Native.

The terminal is configured to display the received information through a user-friendly graphical interface. The terminal can also obtain the user’s current location with a GPS receiver or other positioning technology and transmit this location information to the server. The server uses this location data to provide personalized or location-relevant regional information to the user, such as local event alerts or congestion warnings.

The user can enter a prompt sentence into the terminal, such as, “Please summarize the traffic situation near XX station yesterday” or “What was the most crowded time at the west entrance yesterday?” Upon receiving the prompt, the server generates a corresponding prompt sentence for input to a generative AI model. The generative AI model produces prediction information or summarized reports based on the latest and historical data, which the server returns to the user’s terminal for display.

For example, when the user asks, “Summarize the emotional trends of restaurant owners in the shopping district last weekend,” the server will analyze the sentiment classification data and provide an answer such as, “Most restaurant owners reported positive emotions on Saturday, attributed to a food festival that increased customer traffic.”

The server may also be equipped with capabilities to automatically generate and update prompt sentences for the generative AI model based on the most recent analysis of image data, character data, and spatiotemporal trends, which enables the system to deliver up-to-date and contextually relevant information to users and decision makers. Furthermore, the server can produce index information to support resource allocation or strategic planning by outputting key indicators derived from prediction information or correlation results.

The system can utilize networked servers and databases (such as commercially available server hardware and database platforms), modern smartphones as user terminals, and currently available software libraries and cloud services for image analysis, speech-to-text conversion, emotion analysis, data storage, and AI model inference—enabling practical implementation and scalability of the proposed invention.

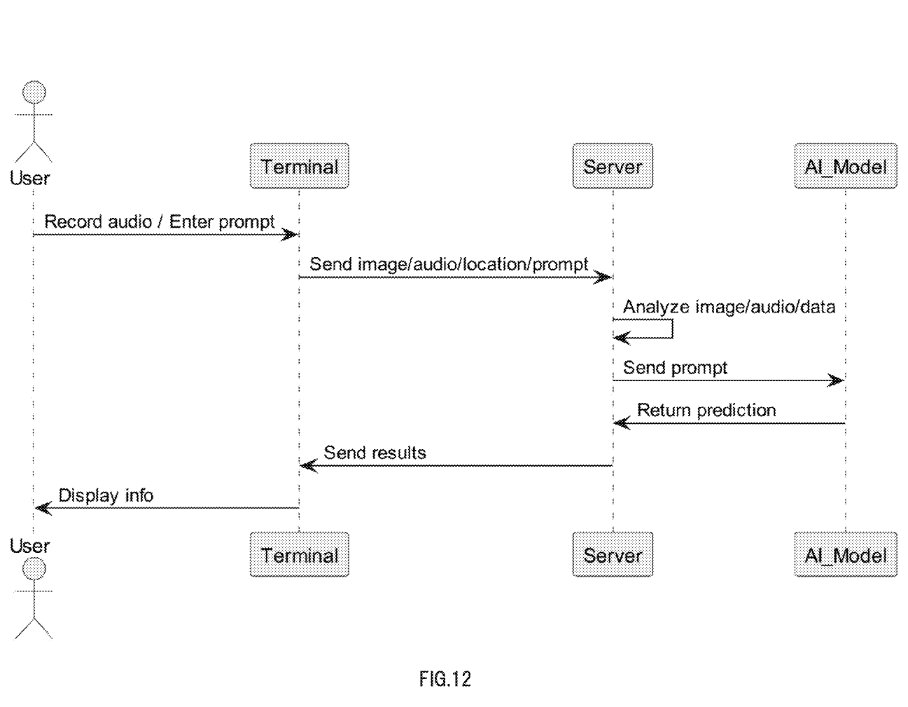

The following describes the processing flow using FIG. 12.

### Step 1

The server receives image data as input from visual information acquisition devices, such as networked cameras installed at multiple locations in the region. Based on the received image data, the server uses image recognition software, such as OpenCV and TensorFlow, to detect and count the number of specific objects, such as people or vehicles, present in each image. The output of this step is the object count result, which is stored in a storage device or database for later processing.

### Step 2

The user collects audio information by recording interviews or conversations with local stakeholders using the microphone function on the terminal (such as a smartphone). The terminal takes the audio file as input and uploads it to the server through a secure connection. The output is the audio file, which is available to the server for further analysis.

### Step 3:

The server receives the audio file as input and uses speech recognition processing, such as a cloud-based speech-to-text service, to convert the audio data into character information (text). The server then processes the transcribed text with an emotion classification module, such as a sentiment analysis engine, to classify the emotion as positive, negative, or neutral. The output of this step is a set of character information paired with emotion labels, which is stored in the system’s database.

### Step 4:

The server aggregates object count data from images, emotion classification results from text data, and relevant spatiotemporal information as input. The server uses statistical analysis software, such as Python libraries, to perform data processing such as correlation analysis or trend detection. The output of this step is a set of analyzed results, for example, the relationship between crowd density and reported emotions, which is stored in the database and made available for user queries.

### Step 5:

The terminal collects location information from the user using its integrated location information detection device, such as GPS. The terminal sends the current geographic coordinates as input to the server. The server uses the received location data to filter relevant regional information from the database and provide localized data, such as congestion alerts or local event information, to the user. The output is customized regional information displayed on the terminal.

### Step 6:

The user inputs a prompt sentence into the terminal, such as a question about current or past regional situations. The terminal sends this prompt as input to the server. The server receives the user’s prompt, accesses related data from the database and analysis results, and generates a new prompt sentence formatted for a generative AI model. The server provides this prompt as input to the AI model, which processes it and returns prediction information or a summarized answer as output. The server sends this prediction information back to the user’s terminal for display.

### Step 7:

The server generates display information, including visualization data such as graphs, heatmaps, or summary texts, based on prediction information, analyzed results, and the user’s location. The server provides the generated display information as output to the terminal. The terminal displays the information on its graphical interface, allowing the user to intuitively understand the regional situation and take appropriate actions.

### Step 8:

The server generates and outputs index information for resource allocation or policy planning based on the prediction information and analysis results. The input for this step is the prediction and analysis data, and the output is a set of index values or recommendations, which may be used by decision-makers or displayed to users for planning purposes.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In current urban and regional environments, formulating effective regional activation strategies is increasingly difficult due to rising population density, complex traffic patterns, and dispersed data sources. Existing systems lack the capability to collectively and dynamically analyze heterogeneous regional data, such as visual, audio, and emotional information, to generate context-sensitive proposals or forecasts. Furthermore, current methods do not enable real-time integration of multi-modal data analysis, time series prediction, and automated strategic planning supported by generative artificial intelligence models. There is a need for a system that can process, correlate, and interpret diverse regional data streams to support rapid and effective resource allocation and decision-making.

The specific processing by the specific processing unit 290 of the data processing device 12 in Example 2 is realized by the following means.

The present invention provides a server comprising a processor configured to acquire, analyze, and correlate image, video, audio, text, and emotional data from a plurality of regional sources; convert audio to text; classify emotional states; perform statistical and time series analysis; generate and provide visualizations; dynamically construct prompt sentences based on existing data trends; and generate actionable strategy or policy information by interacting with a generative AI model. This enables real-time, integrated, and predictive analysis of complex regional data, supporting the creation of evidence-based regional activation proposals and resource allocation plans.

The term “information acquisition device” refers to a hardware apparatus, such as a camera or sensor, configured to collect data including images, video, or environmental information from a physical region.

The term “image information” refers to visual data, such as still photographs or frames, captured by an information acquisition device for the purpose of analysis.

The term “video information” refers to a sequence of temporally continuous visual data captured and recorded by an information acquisition device, which may include moving images or video streams.

The term “personal terminal device” refers to a portable user-operated electronic apparatus, such as a smartphone or tablet, capable of capturing and transmitting audio or other user-generated data to the system.

The term “audio information” refers to sound data, including spoken words or environmental noise, collected by a personal terminal device or microphone.

The term “speech recognition processing” refers to a computational process by which audio information is analyzed and converted into corresponding text information using software algorithms.

The term “text information” refers to data in textual or character-based format, including audio-derived transcriptions or manually entered input.

The term “natural language processing” refers to computational techniques for analyzing and processing human language expressed in text, enabling interpretation and classification such as emotion or intent.

The term “emotional classification information” refers to analytical results representing the emotional state (such as positive, negative, or neutral) conveyed by a unit of text information, identified using natural language processing techniques.

The term “statistical analysis methods” refers to mathematical or computational procedures, including correlation or regression analysis, applied to multi-source data sets to discover relationships or trends.

The term “visualization dataset” refers to structured data or results generated from analytical processing, formatted in a manner suitable for graphical display using visualization tools.

The term “time series analysis model” refers to a mathematical or algorithmic approach used to analyze sequential data points collected over time in order to forecast future values or trends.

The term “prompt sentence” refers to an input statement or question generated by the processor, intended for submission to a generative artificial intelligence model to elicit a contextually relevant response.

The term “generative AI model” refers to a machine learning-based artificial intelligence system that produces novel data or responses, such as strategies or forecasts, in accordance with a provided prompt sentence.

The term “resource allocation indicator” refers to analytical information or scoring generated by the system, which is used to guide the distribution of resources or support policy decisions.

The term “policy information” refers to actionable guidelines, recommendations, or plans generated by the system to support regional management or activation strategies.

### Preferred Embodiment of the Invention

The invention may be implemented using a system configuration comprising a server, multiple information acquisition devices such as cameras and environmental sensors deployed throughout a region, and personal terminal devices such as smartphones or tablets used by individual users. The server includes a processor, memory, storage, and network interfaces, and operates software components required to execute various data analysis and management functions. The software employed by the server may include image recognition frameworks (such as general-purpose neural network libraries), speech-to-text processing modules, natural language processing engines, statistical analysis tools (such as data manipulation and machine learning libraries), visualization platforms, and a generative artificial intelligence model.

The server is configured to acquire image and video information from distributed information acquisition devices via a communication network. For this purpose, each device captures visual data (such as images and video streams) and transmits them to the server. For example, fixed cameras installed at public squares, commercial areas, or transportation hubs periodically send video frames to the server over a secure wired or wireless network.

The server processes the image or video data on its processor. It uses a machine learning-based object detection model, such as a general-purpose neural network framework, to detect and count specific targets, such as pedestrians and vehicles, in each frame. The counting results are stored in a database together with metadata, such as location and timestamp information.

The user utilizes a personal terminal device to capture audio data from various locations within the region. For instance, a user may record a conversation or environmental sound using a smartphone application provided by the system and upload the recorded audio file to the server.

The server receives the audio information and applies a speech recognition module, such as a cloud-based speech-to-text service, to perform transcription, converting the spoken content into text information. This text is analyzed by a natural language processing engine operating on the server. The engine performs sentiment analysis, classifying each piece of text as positive, neutral, or negative, thereby producing emotional classification information.

The server then aggregates the image information, video information, textual information, and emotional classification information. Utilizing statistical analysis tools such as tabular data processing and correlation analysis libraries, the server conducts multidimensional data analysis to uncover relationships and trends across these information sets.

For visualization, the server generates structured datasets, formatted for compatibility with commonly-used data visualization platforms. These datasets are transmitted to the personal terminal device, where the user can view real-time dashboard graphs showing, for example, traffic volumes or collective sentiment trends at different locations throughout the region.

The server performs time series analysis on historical data using a time series analysis model, forecasting future trends such as expected pedestrian flow or changing sentiment levels in specific areas.

To provide strategic proposals for regional activation or decision support, the server constructs a prompt sentence, automatically or based on user input, which summarizes the current context or problem in the region. An example of such a prompt sentence is:

“Based on historical data, identify the main causes of negative sentiment in this area and suggest ways to improve public satisfaction.”

Another example prompt is:

“Predict trends in public sentiment for the next event in this area and propose the best marketing strategy.”

The server inputs the prompt sentence and relevant analytical results into the generative AI model, which generates actionable strategy information, such as event planning recommendations or new resource allocation policies. The server then outputs these proposals to the personal terminal device for user review and implementation.

By applying this configuration, the invention enables comprehensive, real-time analysis and intelligent strategy generation based on integrated multimodal regional data streams, supporting evidence-driven regional management and development.

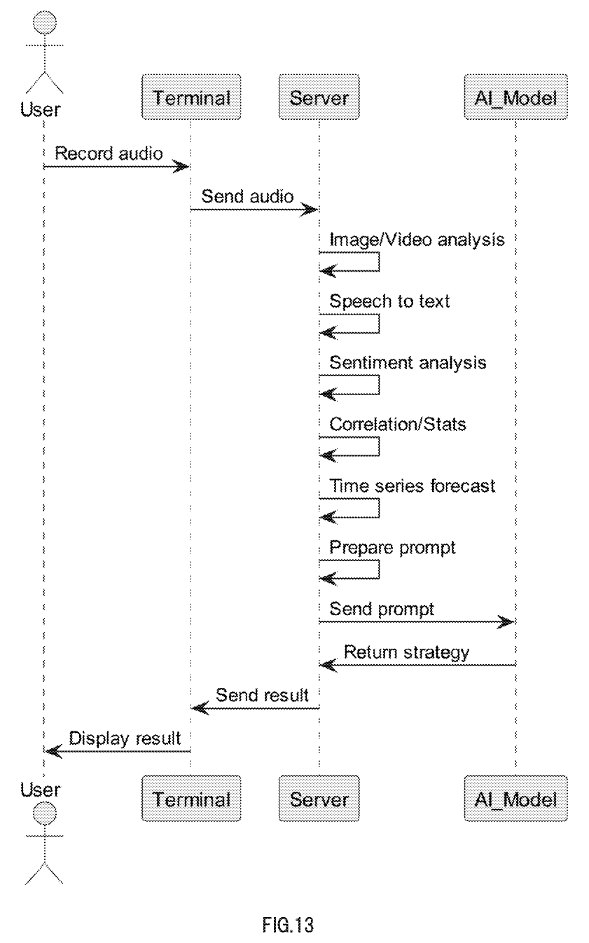

The following describes the processing flow using FIG. 13.

### Step 1

The server receives image and video data from multiple information acquisition devices installed in different regions. The input for this step is raw image or video files captured by cameras or similar devices. The server executes an image recognition algorithm, such as a neural network-based object detection model, to process each image or video frame. The output is structured data containing the number of detected targets (such as pedestrians or vehicles), along with metadata including location and timestamp. The server then stores this processed data in a database.

### Step 2

The user captures audio data representing conversations or environmental sounds using a personal terminal device, such as a smartphone. The input for this step is an audio file in a standard format (such as WAV or MP3) recorded on-site. The terminal device uploads this file to the server for further processing. The output is the successful transmission of the audio file to the server.

### Step 3:

The server accepts the uploaded audio file and performs speech recognition processing using a speech-to-text module, such as a cloud-based speech-to-text service. The input is the audio file received from the user. The output is the text information, which is a transcription of the audio data. The server stores the transcribed text in association with the audio file and relevant metadata.

### Step 4:

The server analyzes the transcribed text using a natural language processing engine to classify it according to emotional state. The input for this step is the text information derived from the speech recognition process. The server executes sentiment analysis to categorize the text as positive, negative, or neutral, and records an associated confidence score. The output is emotional classification information linked to the original text and corresponding metadata.

### Step 5:

The server integrates the processed image recognition data, transcribed text, and emotional classification information. The input for this step is aggregated data from the previous processing steps. The server applies statistical analysis methods, such as correlation analysis, on these multi-source data sets to identify relationships or trends between regional factors, such as pedestrian density and collective sentiment. The output is analytical results that describe significant correlations or patterns, which are stored in the database.

### Step 6:

The server prepares datasets formatted for visual representation by a data visualization platform. The input for this step is the analytical result data produced by the statistical correlation analysis. The server converts this data into visualization-ready datasets, such as CSV or JSON files, and transmits them to the personal terminal device. The output is visual dashboards or charts displayed on the user’s terminal device, enabling users to understand regional trends intuitively.

### Step 7:

The server performs time series analysis using historical data for trend forecasting. The input is accumulated historical records of image recognition, sentiment, and other analytical metrics. The server runs a time series prediction model to forecast future regional phenomena, such as expected pedestrian traffic or shifts in sentiment. The output is predictive data summarizing future trends, which are recorded for use in strategy planning.

### Step 8:

The server generates a prompt sentence that summarizes the current situation or planning objective, either automatically or based on user input. The input for this step is the current analytical, prediction, and correlation data. The server formulates a context-aware prompt sentence and submits it, along with relevant data, to a generative AI model. The output is a strategy or proposal generated by the AI, such as recommendations for regional activation or resource allocation.

### Step 9:

The server provides the strategy or proposal generated by the generative AI model to the user through the terminal device interface. The input for this step is the content returned by the generative AI model in response to the prompt sentence. The server formats and delivers this content to the user’s terminal as a recommendation, report, or actionable plan. The output is the clear presentation of an AI-generated decision support proposal for review and implementation by the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In contemporary urban environments, there is a demand for systems that can understand residents’ emotions and regional trends in real time to facilitate effective decision-making and regional revitalization. Conventional methods lack the capability to process, analyze, and visualize large volumes of multimodal data, including environmental conditions and user sentiment, in a timely and intuitive manner. As a result, timely decision support and the formulation of actionable strategies for local planning are hindered. There is also a need for adaptive systems that can dynamically refine their analyses and predictions by integrating multiple data sources and leveraging advanced artificial intelligence models.

The specific processing by the specific processing unit 290 of the data processing device 12 in Application Example 2 is realized by the following means.

The present invention provides a server comprising a processor configured to collect and process environmental data from imaging and detection devices, convert audio data from user terminals into text and extract emotional attributes, perform correlation analysis between environmental and user-provided information, dynamically generate prompt sentences containing analysis results, input the prompt sentences to a generative AI model to obtain prediction information for future regional attributes, and generate and output decision support information in a visualized format. This enables timely, data-driven support for regional planning by integrating multimodal data, performing advanced analysis, and adapting prompt generation for enhanced prediction accuracy and user intuitiveness.

The term “imaging device” refers to a generic apparatus capable of capturing visual data, such as cameras or video sensors, installed in various spatial regions to monitor environmental conditions.

The term “detection device” refers to a general-purpose sensor or apparatus that detects physical phenomena or environmental parameters, including but not limited to motion sensors, environmental sensors, or other devices that collect non-visual data.

The term “environmental conditions” refers to the physical characteristics or states of a given spatial region, including objects, events, luminance levels, and other observable phenomena.

The term “image processing” refers to computational techniques applied to image data acquired by imaging devices to extract numerical or descriptive information about objects or phenomena contained within the images.

The term “user terminal” refers to an electronic device operated by a user, such as a smartphone, tablet, or computer, which is capable of receiving, transmitting, or recording data including audio inputs.

The term “audio data” refers to digital representations of sound, including but not limited to spoken feedback, opinions, or comments recorded from users through user terminals.

The term “speech recognition” refers to the process of converting audio data, particularly spoken words, into textual data using computational algorithms or cloud-based recognition services.

The term “language processing” refers to techniques within the domain of natural language processing that enable the extraction and classification of information, such as emotional attributes, from textual data.

The term “emotional attributes” refers to the classification of text data according to the inferred sentiment or emotion expressed, such as positive, negative, or neutral.

The term “correlation analysis” refers to a statistical process for identifying relationships or dependencies between two or more datasets, such as between environmental data and user sentiment data.

The term “prompt sentence” refers to a formulated input statement or query generated based on prior analysis results, designed to elicit relevant outputs from a generative artificial intelligence model.

The term “generative AI model” refers to a type of artificial intelligence system capable of generating predictions, suggestions, or other outputs in response to prompt sentences, and which may include language models or similar architectures.

The term “prediction information” refers to forecasted or inferred data output by a generative AI model regarding anticipated regional attributes or conditions for a specified future period.

The term “decision support information” refers to processed and synthesized data presented to users in a visualized format, intended to facilitate timely and informed decision-making for regional or organizational planning.

The term “visualized format” refers to graphical or otherwise intuitive representations of data, such as charts, dashboards, or graphical summaries, displayed on a terminal to enhance user comprehension.

A server is employed as the central processing unit of the system. The server is equipped with a processor and memory capable of executing image processing, speech recognition, natural language processing, data integration, statistical analysis, correlation analysis, prompt generation, and interfacing with a generative AI model. The system further includes multiple imaging devices and detection devices, such as general-purpose cameras and environmental sensors, installed throughout urban or designated spatial regions. Users operate user terminals, such as smartphones or computers, to input audio feedback and receive analysis results.

The server collects real-time environmental data from the imaging and detection devices. For example, the imaging devices may be networked digital cameras installed at intersections, and the detection devices may include sensors for collecting parameters such as light intensity or crowd movement. The server applies an image processing library, such as OpenCV, to the captured images to detect and count objects or phenomena, like people, vehicles, or specific environmental events.

Simultaneously, the user provides spoken feedback using the user terminal. The terminal sends the captured audio data to the server over a secure communication network. The server uses a cloud-based speech recognition service, such as a generic speech-to-text API, to convert the received audio data into text. Subsequently, the server applies a language processing library, for example a tool similar to NLTK or spaCy, to the text data and extracts emotional attributes by classifying the sentiment as positive, negative, or neutral.

The server performs correlation analysis between the environmental data derived from image processing and the sentiment data from user feedback. Using a data analysis library, such as pandas or a generic statistical computation library, the server determines relationships or trends between the number of detected objects/events and the sentiment expressed by the users.

The server dynamically generates a prompt sentence summarizing the correlation analysis results and relevant contextual data. This prompt sentence is then input into a generative AI model, such as a generic large language model, using an API connection. The generative AI model produces prediction information regarding future regional attributes or trends.

Based on the prediction information and the results of the correlation analysis, the server generates decision support information. This information is sent to the user terminal, which displays it in a visualized format, such as graphs or dashboards, allowing the user to intuitively interpret trends and suggested actions.

For example, during a city festival, the system may collect images from various cameras to count the number of attendees, while the user terminals gather spoken impressions about the event. The server might detect a surge in positive sentiment and high attendance, dynamically generate a prompt such as:

"Analyze how the regional music event has affected residents' emotions and generate specific strategic suggestions for future event planning."

The generative AI model could respond with suggestions such as increasing the diversity of performers or optimizing event logistics for larger crowds. The terminal then visualizes this analysis and proposals for the user, supporting timely and effective regional planning decisions.

In summary, this embodiment enables real-time collection, processing, and analysis of multimodal data, dynamic generation of prompts for AI prediction, and user-friendly display

of analyzed results and forecasts, thus enhancing evidence-based regional strategy development.

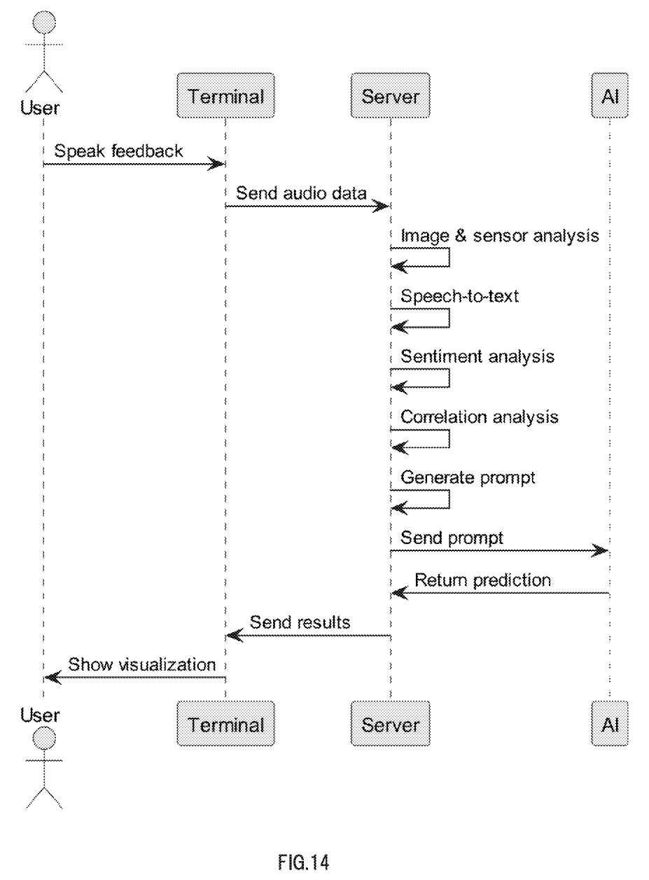

The following describes the processing flow using FIG. 14.

### Step 1

The server receives real-time image data from multiple imaging devices and environmental sensors installed in various regions. The input is raw image and environmental sensor data. The server preprocesses the images by resizing, adjusting contrast, and converting to a standard format to ensure consistency for further analysis. The output is standardized image and sensor data ready for processing.

### Step 2

The server analyzes the standardized images using image processing algorithms, such as OpenCV object detection. The input is standardized image data. The server detects and counts objects or phenomena, such as people, vehicles, or lighting conditions, and records this quantitative information. The output is a dataset containing object counts and environmental parameters for each location and time.

### Step 3:

The user submits spoken feedback or comments via the user terminal, such as a smartphone or computer application. The input is the user's audio data. The terminal records the audio file and transmits it to the server. The output is the captured audio data associated with the user's metadata.

### Step 4:

The server receives the audio data from the terminal. The input is the user's raw audio data. The server performs speech recognition using a cloud-based speech-to-text API to convert speech into a text transcript. The output is transcribed textual data representing the user's spoken content.

### Step 5:

The server processes the transcribed text using a natural language processing library, such as NLTK or spaCy. The input is the transcribed text data. The server analyzes the sentiment to classify the emotional attributes of the user's statement as positive, negative, or neutral. The output is the sentiment classification result, which is linked to the user's metadata.

### Step 6:

The server integrates the object count and environmental data from image analysis with the sentiment data obtained from speech recognition. The input is the object/environmental dataset and the sentiment dataset. The server performs correlation analysis using statistical methods (e.g., Pearson correlation) to identify trends or relationships between environmental changes and collective sentiment. The output is a correlation analysis report highlighting significant findings.

### Step 7:

The server generates a prompt sentence summarizing the major aspects of the correlation analysis and relevant environmental and sentiment data. The input is the correlation analysis report and contextual information. The server formulates a natural language prompt sentence designed to elicit targeted predictions from a generative AI model. The output is a crafted prompt sentence.

### Step 8:

The server inputs the prompt sentence to the generative AI model via an API and receives prediction information about future regional trends or recommended strategies. The input is the prompt sentence. The server submits the prompt and collects the AI-generated output, which may include scenario predictions or strategic suggestions. The output is the prediction information and recommendations.

### Step 9:

The server compiles decision support information integrating the prediction information and analysis results. The input is the prediction information and correlation findings. The server prepares the data in a user-friendly, visualized format, such as graphs or dashboards, for interpretation. The output is a structured visualization dataset.

### Step 10:

The terminal receives the visualized decision support information from the server. The input is the structured visualization dataset. The terminal displays graphical dashboards, trend lines, and key suggestions on the user interface. The output is the visual presentation of analysis and recommendations shown to the user.

### Step 11

The user reviews the visualized information and proposed strategies on the terminal. The input is the graphical user interface display. The user interprets trends, considers suggestions, and may initiate new action plans or provide further feedback based on the analysis. The output is increased situational awareness, informed planning, or initiated responses for regional improvement.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### SECOND EXEMPLARY EMBODIMENT

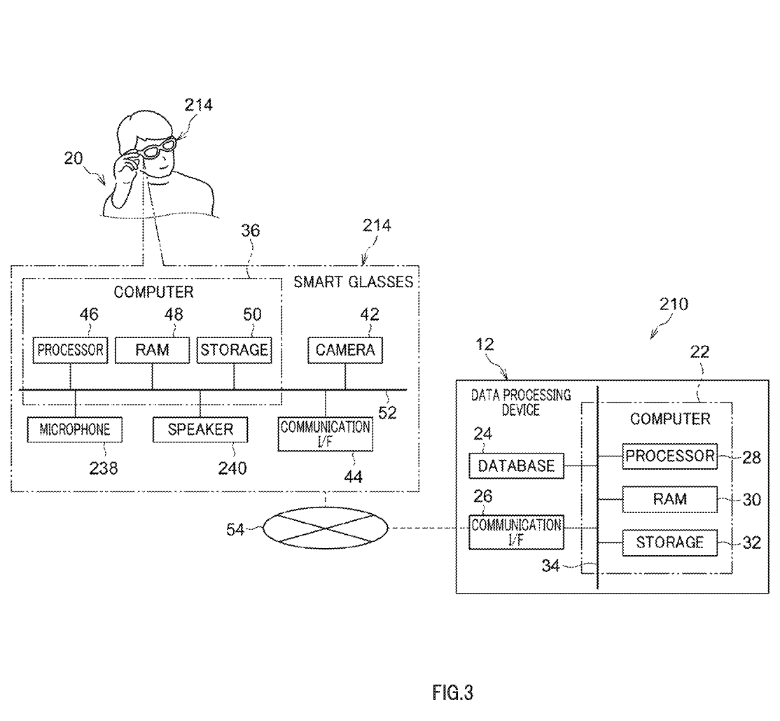

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

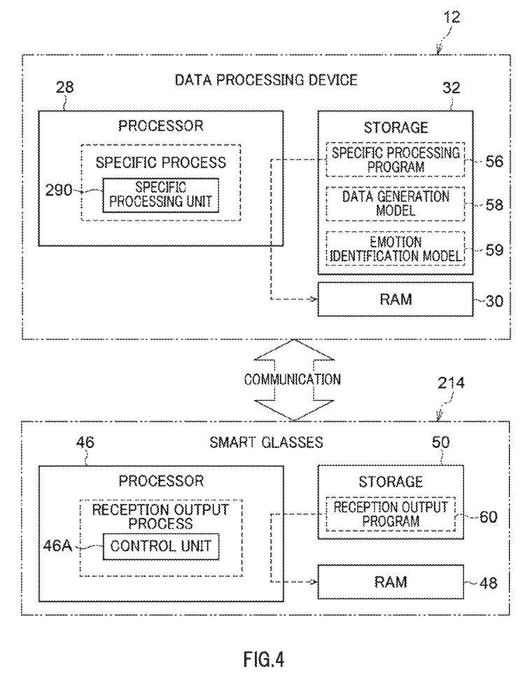

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### THIRD EXEMPLARY EMBODIMENT

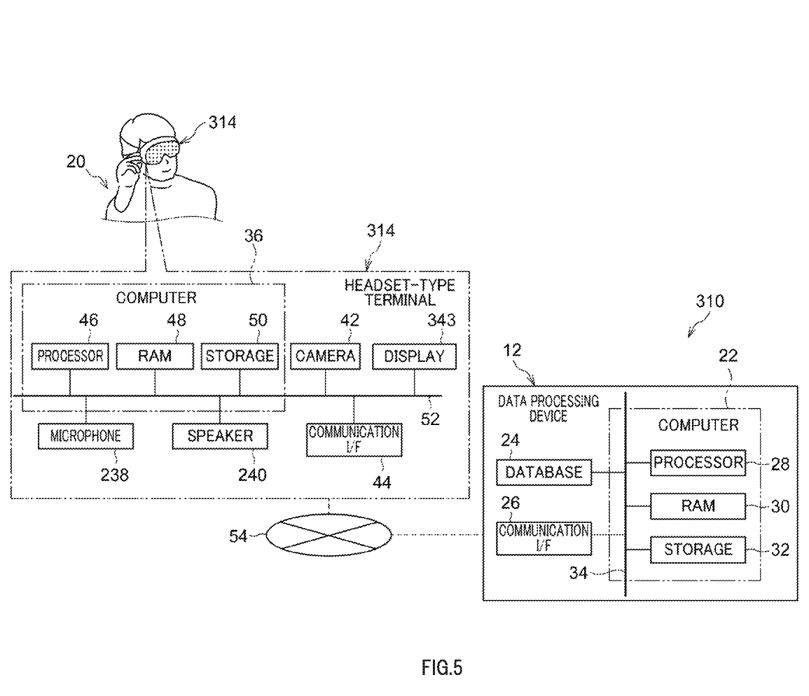

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

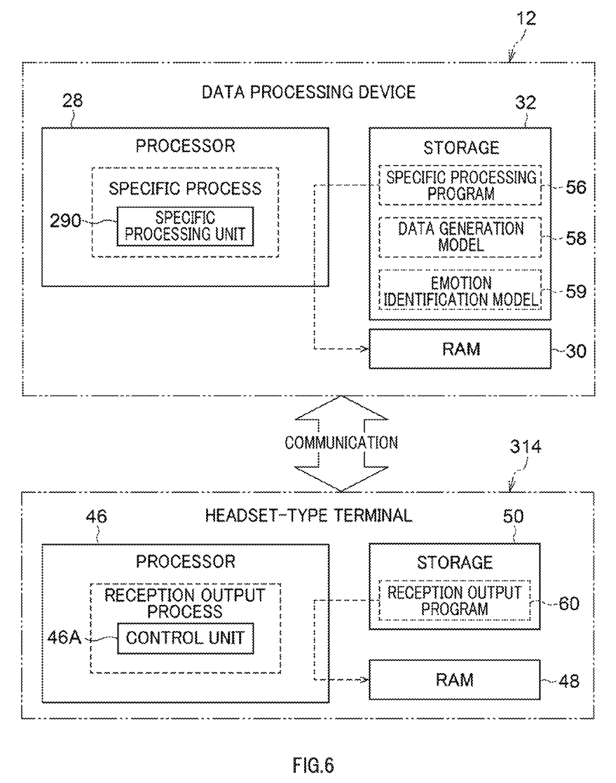

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### FOURTH EXEMPLARY EMBODIMENT

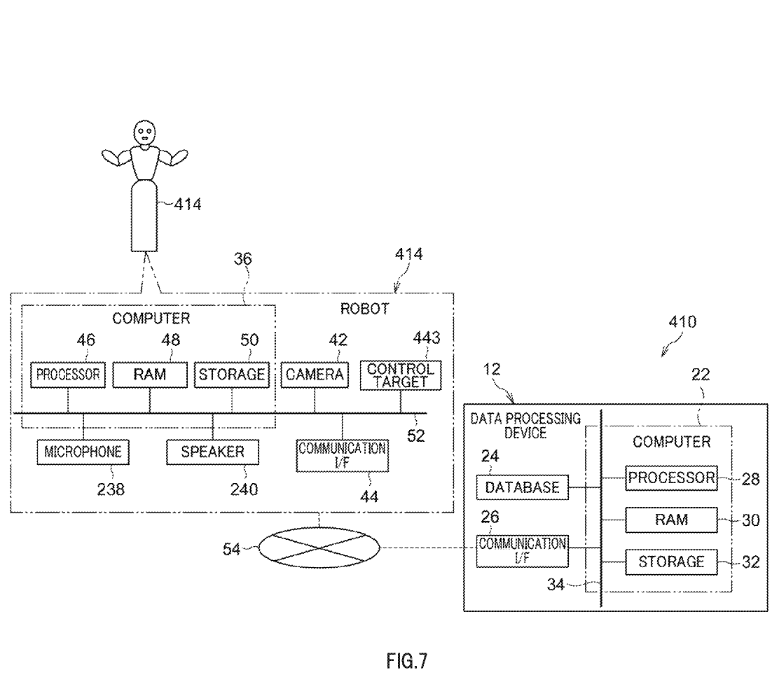

FIG. 7 illustrates an example of a configuration of a data processing system 410 according to a fourth exemplary embodiment.

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

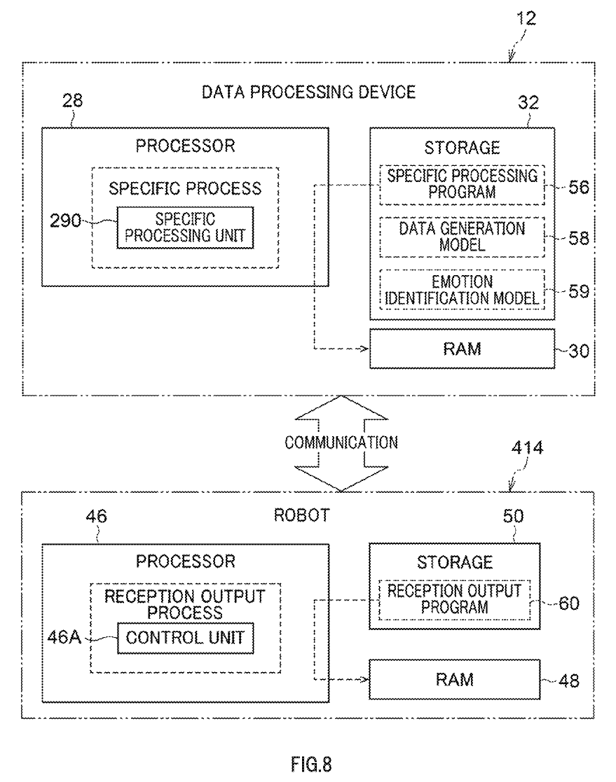

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

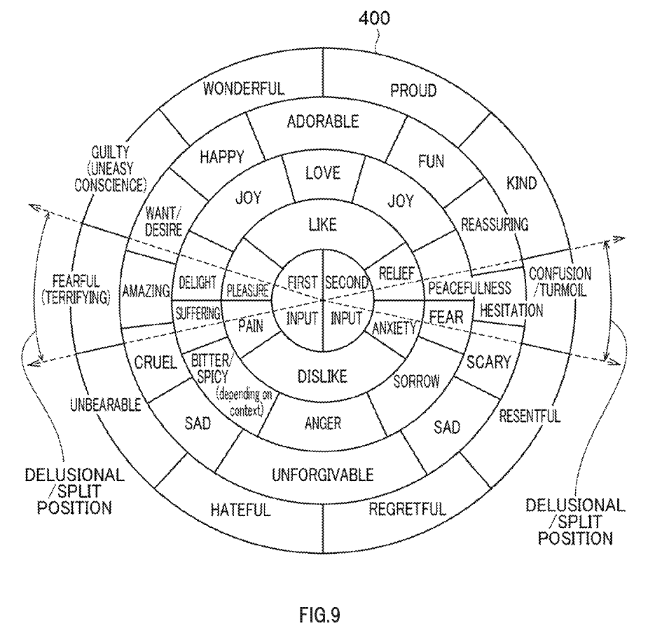

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o’clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don’t want to feel this way ever again” and “I don’t want to be chided again” is experienced in a robot. Another is a positive emotion in the area of “desire” on the reaction side. In other words, there are times when a positive feeling such as “desire more” and “want to know more” is experienced.

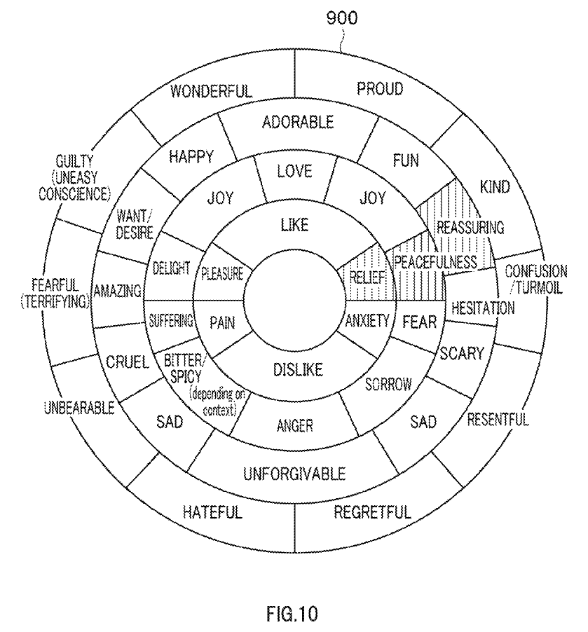

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added,

and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,

wherein the processor is configured to

acquire observation data including object information, moving object information, and illuminance information related to a plurality of spatial regions using information collection means comprising sensor devices, recording devices, or communication devices,

acquire hearing data including opinion content from regional stakeholders,

generate an instruction sentence based on the observation data and hearing data for predicting regional environmental characteristics at multiple future time points,

input the instruction sentence into a generative information processing model and obtain predictive data indicating the regional environmental characteristics for the multiple time points from the generative information processing model,

generate and output indicator data for use in resource allocation policies or business operation plan formulation based on the predictive data,

analyze and process data using information analysis methods including natural language processing, image processing, and time series analysis, and a linkage module to collaborate with the generative information processing model,

and visualize and present the indicator data per region or per attribute using a visualization means.

### (Supplementary 2)

The system according to supplementary 1,

wherein the processor is configured to

analyze the observation data and the hearing data over a time series to extract region environmental change trends, and dynamically change the instruction sentence input to the generative information processing model based on the extracted environmental change trends.

### (Supplementary 3)

The system according to supplementary 1,

wherein the processor is configured to

organize the predictive data obtained from the generative information processing model by each type of regional environmental characteristic, and sequentially generate multiple instruction sentences for resource allocation policy or business operation plan formulation according to the result of the organization.

### Application Example 1

### (Supplementary 1)

A system comprising a processor,

wherein the processor is configured to

acquire image information from a visual information acquisition device, recognize and calculate the quantity of predetermined objects within the image information,

convert audio information acquired from an acoustic acquisition device to character information by speech recognition processing, and perform emotion classification processing on the character information,

execute correlation analysis among a plurality of pieces of information including data obtained from the image information and the character information,

extract up-to-date regional information for a spatial area and provide it to a user terminal based on current location information acquired from a location information detection device,

generate a prompt sentence based on the information set, input the prompt sentence to a generative AI model, and acquire prediction information including future regional situations from the generative AI model,

convert obtained prediction information or analysis data into display information and provide the display information to a user through a display device, and

generate and output index information applicable to resource allocation or policy planning based on the prediction information.

### (Supplementary 2)

The system according to supplementary 1,

wherein the processor is configured to

analyze the image information, character information, and associated spatiotemporal data on a period basis, extract environmental change patterns, and dynamically change the prompt sentence input to the generative AI model based on the extracted results.

### (Supplementary 3)

The system according to supplementary 1,

wherein the processor is configured to

classify the prediction information acquired from the generative AI model and consecutively generate a plurality of prompt sentences related to resource allocation or policy planning based on the classification results.

### Example 2

### (Supplementary 1)

A system comprising a processor,

wherein the processor is configured to

acquire image information and video information collected from a plurality of information acquisition devices installed in multiple regions, and analyze the information to count the number of targets within a predetermined area,

convert audio information obtained from a personal terminal device into text information by performing speech recognition processing,

classify the text information into emotional states using natural language processing,

analyze correlations between multiple sets of information, including image information, video information, text information, and emotional classification information, using statistical analysis methods,

generate a visualization dataset based on the analysis results and output the dataset to a data visualization output device,

apply a time series analysis model to the image information, video information, text information, and emotional classification information according to temporal transitions to predict future trends,

generate a prompt sentence for generation of regional activation strategies or decision support proposals based on the analysis results or future trend predictions, and input the prompt sentence to a generative AI model to obtain strategy information generated by the model,

and generate and output resource allocation indicators or policy information based on the strategy information.

### (Supplementary 2)

The system according to supplementary 1,

wherein the processor is configured to

analyze the image information, video information, text information, or emotional classification information on a time period basis to extract fluctuation trends in regional environmental characteristics, and dynamically change the prompt sentence for input to the generative AI model based on the extraction results.

### (Supplementary 3)

The system according to supplementary 1,

wherein the processor is configured to

organize the strategy information obtained from the generative AI model by regional environmental characteristic, and to continuously generate a plurality of prompt sentences according to the output of resource allocation indicators or decision support proposals.

### Application Example 2

### (Supplementary 1)

A system comprising a processor,

wherein the processor is configured to:

collect information indicative of environmental conditions from a plurality of imaging devices and detection devices installed in multiple spatial regions, and process the collected information using image processing to compute numerical information related to objects or phenomena;

convert audio data received from a user terminal into text using speech recognition, and extract and classify emotional attributes from the text using language processing;

integrate the processed environmental information and the processed user-provided information, perform correlation analysis between the datasets, and dynamically generate a prompt sentence including results of the correlation analysis;

input the generated prompt sentence to a generative AI model and obtain prediction information regarding region-related attributes for a specified future period;

generate decision support information based on the prediction information and correlation analysis results, and output the decision support information in a visualized form to a terminal.

### (Supplementary 2)

The system according to supplementary 1,

wherein the processor is configured to analyze the environmental information and the user-provided information for each time period, extract trends and features, and dynamically

modify the prompt sentence to be input to the generative AI model based on the extracted results.

### (Supplementary 3)

The system according to supplementary 1,

wherein the processor is configured to organize the prediction information obtained from the generative AI model according to attributes, and sequentially generate a plurality of prompt sentences based on the organized results.

What is claimed is:

1. A system comprising a processor,
wherein the processor is configured to:
acquire observation information comprising environmental information including structures, moving objects, and luminance states in a plurality of spatial regions,
acquires interview information provided by regional stakeholders as opinion information,
generate an instruction sentence for predicting regional environmental characteristics for a plurality of future periods based on the observation information and the interview information,
input the instruction sentence generated by the instruction sentence generation to a generative AI model, and acquire prediction information indicating the regional environmental characteristics for the plurality of future periods from the generative AI model, and
generate and outputs indicator information applicable to resource allocation policy or business planning based on the prediction information.

2. The system according to claim 1, wherein the processor is further configured to analyze the observation information and the interview information for each period to extract regional environmental variation trends and dynamically changes the prompt sentence to be input to the generative AI model based on the extraction results of the regional environmental variation trends.

3. The system according to claim 1, wherein the processor is configured to organize the prediction information obtained from the generative AI model by type of regional environmental characteristic, and consecutively generate a plurality of prompt sentences for resource allocation policy or business planning in accordance with the organized prediction information.
